(19) United States
(12) Patent Application Publication
(10) Pub. No.: US 2011/0072728 A1
(43) Pub. Date: Mar. 31, 2011

(54) PROTECTION DEVICE FOR THE OPENING HATCH OF A VEHICLE

(75) Inventors: Jean-Luc Duinat, Neulise (FR); Xavier Poirmeur, Guyancourt (FR)

(73) Assignee: Nexter Systems, Roanne (FR)

(21) Appl. No.: 12/737,100

(22) PCT Filed: Jun. 10, 2009
(86) PCT No.: PCT/FR2009/000686

§ 371 Date: Dec. 8, 2010

(30) Foreign Application Priority Data
Jun. 10, 2008 (FR) 0803229

(51) Int. Cl. E06B 7/28

(52) U.S. Cl. 49/383

(57) ABSTRACT

The invention relates to a protection device for the opening hatch (1) of a vehicle, the opening hatch being articulated with respect to a vehicle wall (2) by at least one hinge (3).

The device incorporates at least one shoe (7) integral with the opening hatch (1) at one of its rims near to which the hinge or hinges (3) are positioned, such shoe (7) engaging below a bearing surface (10) integral with the wall (2) when the opening hatch (1) is in the closed position, the cooperation of the shoe (7) with its bearing surface (10) being such that the opening hatch (2) can not be distanced from the wall even if the hinge or hinges (3) have been destroyed.

### TECHNICAL FIELD OF THE INVENTION

The technical scope of the invention is that of protection devices for vehicles and namely protections for the opening hatches of this vehicle (such as hatches or doors).

### TECHNICAL BACKGROUND OF THE INVENTION

Armoured vehicles generally incorporate protections to ensure the resistance of the walls to the impact of projectiles or to the blast of explosive detonations.

If it is relatively simple to protect a wall, it is more difficult to ensure the protection of an opening hatch.

Indeed, opening hatches are generally mounted able to pivot on hinges, which constitute weak points that can be destroyed during the ignition of an explosive near to the vehicle.

This risk is further increased today because of the presence in operation zones of IEDs (Improvised Explosive Devices), which are homemade explosive devices but which can implement substantial masses of explosive or other energetic material (petrol, gas).

Indeed, the explosion of an IED can cause highly substantial damage to a structure such as the vehicle cab. If multi-point locks are able to ensure the retaining of the door edges to a certain extent, the hinges may nevertheless be destroyed.

The door's rebounding on the wall further to the explosion will cause it to be torn off at the hinges thereby eliminating the protection it provided for the occupants of the vehicle.

By patent EP-0788911 and utility model DE-29600320 a door structure for an automobile is known that comprises a frame formed of vertical posts fitted with half-hinges and other accessories such as a mounting case for a lock. However, these documents do not describe any means to prevent the hinges being torn off further to the door's rebounding after an explosion to the exterior of the vehicle.

### DISCLOSURE OF THE INVENTION

The aim of the invention is to propose means to improve the protection of a vehicle's opening hatches.

The invention thereby ensures the reinforcement of the hinges, preventing the opening hatch from being ejected, in the event of an explosive mass being ignited near the vehicle.

Thus, the invention relates to a protection device for the opening hatch of a vehicle, the opening hatch being articulated with respect to a vehicle wall by at least one hinge, device wherein it incorporates at least one shoe integral with the opening hatch at one of its rims near to which the hinge or hinges are positioned, such shoe engaging below a bearing surface integral with the wall when the opening hatch is in the closed position, the cooperation of the shoe with its bearing surface being such that the opening hatch can not be distanced from the wall even if the hinge or hinges have been destroyed.

The shoe may be fixed with respect to the opening hatch and may incorporate a wedge-shaped profile that is engaged under the bearing surface when the opening hatch pivots on its hinges.

The bearing surface may be integral with an inner rim of the opening that is arranged on the vehicle wall and which is blocked by the opening hatch, the bearing surface thus being inside the vehicle when the opening hatch is closed.

A bearing surface and shoe may be positioned at each hinge.

Advantageously, at least one bearing surface and at least one shoe may be positioned between two consecutive hinges.

### DESCRIPTION OF THE DRAWINGS

The invention will become more apparent from the following description of the different embodiments, such description being made with reference to the appended drawings, in which:

FIGS. 1a and 1b showing a partial section of a vehicle opening hatch equipped with a device according to a first embodiment of the invention, view 1b showing the opening hatch in its open position and FIG. 1a showing the same opening hatch in its closed position,

FIGS. 2a and 2b show a partial section of a vehicle opening hatch equipped with a device according to a second embodiment of the invention, view 2b showing the opening hatch in its open position and FIG. 2a showing the same opening hatch in its closed position,

FIG. 3 shows, for this second embodiment, a partial side view of the opening hatch in its open position,

FIG. 4 is analogous to FIG. 3 and shows a partial side view of a third embodiment.

### DETAILED DESCRIPTION OF THE INVENTION

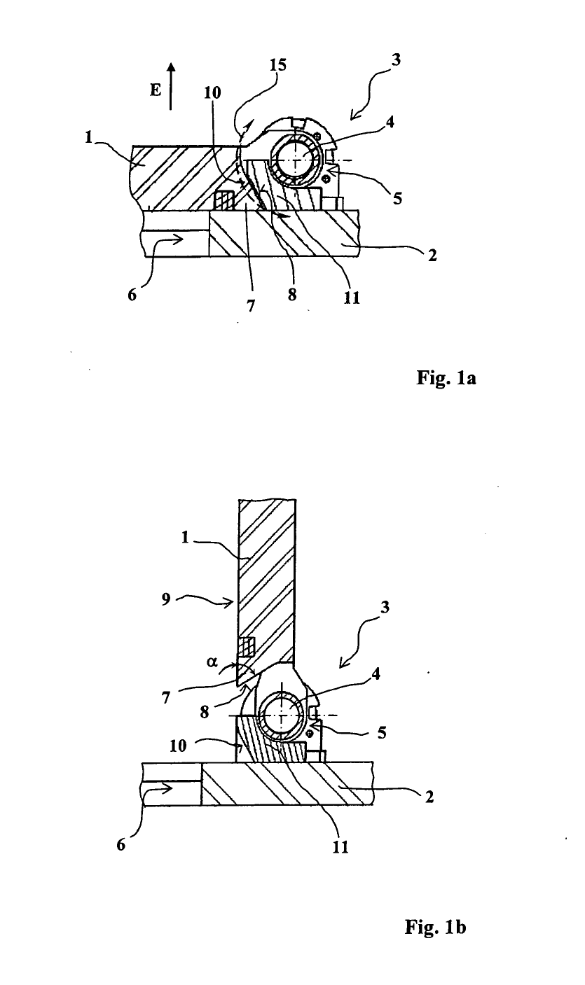

With reference to FIGS. 1a, 1b, a vehicle opening hatch 1 is shown articulated with respect to a wall 2 of the vehicle by a hinge 3. Only one hinge 3 is shown here, but the opening hatch may naturally have several hinges.

The hinge 3 incorporates a hinge pin 4 that here is integral with the opening hatch 1 and which pivots on bearings 5 integral with the wall 2.

The opening hatch 1 in its closed position blocks an opening 6 that is arranged in the wall 2 of the vehicle.

According to this embodiment of the invention, the opening hatch 1 incorporates a shoe 7 that here is constituted by a rim of the opening hatch 1 that forms a plane surface 8 that is inclined at an angle a of less than 90° with respect to the inner face 9 of the opening hatch (FIG. 1b).

When the opening hatch 1 is in the closed position (FIG. 1a), the shoe 7 engages under a matching bearing surface 10 that is integral with at least one block 11 integral with the wall 2. The shoe 7 does not hinder the opening movement of the opening hatch. The circular path taken by the lower edge of the surface 8 of the shoe 7 is shown in Figure la by arrow 15.

The block 11 is attached to the wall, for example by welding. The hinges 3 may be integral with the block or blocks 11 but advantageously, the blocks 11 will be separate from the hinges and attached to the wall by specific joining means.

We can see in FIG. 1a that when the opening hatch is closed the plane surface 8 of the shoe 7 is in contact with the bearing surface 10 of the block 11 (slight play is possible between these surfaces). In this position it is impossible for the opening hatch 1 to be extracted in direction E and the opening hatch 1 may not be distanced from the wall 2 even if the hinge or hinges 3 are destroyed.

Thus, if the hinges 3 are destroyed, the shoe 7 nevertheless ensures the retaining of the opening hatch 1 with respect to the wall 2. The opening hatch thus continues to block the opening 6 and the vehicle crew continues to be protected.

The device according to the invention thus constitutes means to reinforce the protection of the opening hatch 1. It forms a substitute for the hinges 3 should these be destroyed and prevents the opening hatch 1 from rebounding and being ejected.

The shoe 7 may extend over the full length of the rim of the opening hatch in question.

Alternatively, to facilitate the machining operations, a shoe 7 may be provided for each hinge 3. Each shoe will, in this case, be of a length that is greater than or equal to the length of the hinge that it is reinforcing.

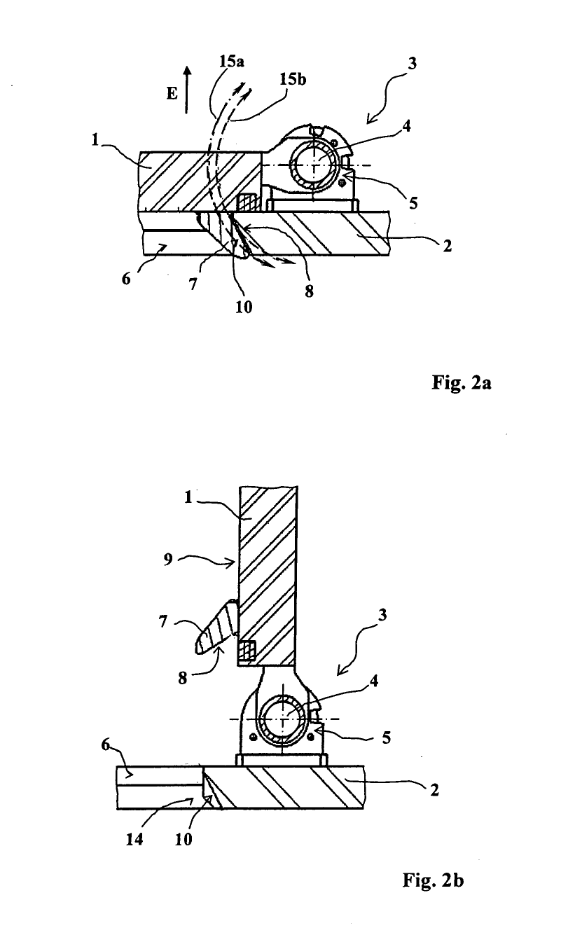

FIGS. 2a and 2b show another embodiment that differs from the previous one in that the shoes 7 are add-on parts that are attached to the inner face 9 of the opening hatch 1. Once again, the shoe 7 does not hinder the opening movement of the opening hatch 1. In FIG. 2a the circular paths taken by the rims delimiting the surface 8 of the shoe 7 are shown by arrows 15a and 15b.

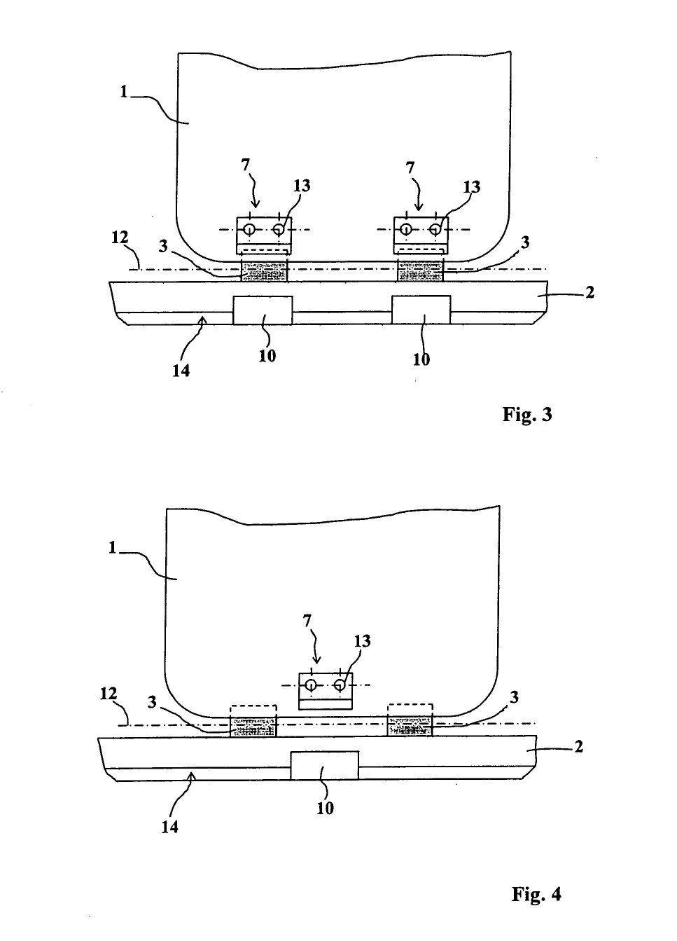

FIG. 3 shows the installation of the shoes 7 on the opening hatch 1. The latter pivots with respect to the wall 2 by means of two hinges 3. The hinge axis of the two hinges is shown as 12.

Each shoe 7 is positioned facing a hinge 3 and is attached to the opening hatch 1 by screws 13. The shoes 7 are here of a width that is slightly greater than that of the hinge 3. Their width may also be less than that of the hinges, the important thing being that the bearing surfaces be sufficient to ensure the required hold.

This embodiment also differs from the previous one in that the bearing surface 10 intended to cooperate with a matching surface 8 of the shoe 7 is integral with an inner rim 14 of the opening 6.

FIG. 3 shows that location of the bearing surfaces 10 which are made in the form of notches arranged in the inner rim 14 facing the hinges 3. The bearing surfaces 10 are thus inside the vehicle when the opening hatch 1 is closed. This embodiment ensures a higher level of protection. Indeed, in the event that the hinges 3 are destroyed, it is the rim of the wall 2 itself that prevents the opening hatch 1 from being torn off. With this embodiment, we are no longer dependant on the mechanical strength of the blocks 11 and their attachment means to the wall 2.

FIG. 4 shows another embodiment of the invention in which a shoe 7 has been put into place between the two hinges 3. This shoe cooperates with a single bearing surface 10 arranged on the inner rim 14 of the opening 6.

It is naturally possible for the invention to be implemented on any type of opening hatch or door. Both for lateral hatches (vehicle doors) and for roof hatches. Indeed, it is also necessary for the hinges of roof hatches to be protected which could also be destroyed in the event of a mine exploding, the shock wave reaching them via the structure of the vehicle itself.

1. A protection device for the opening hatch (1) of a vehicle, the opening hatch being articulated with respect to a vehicle wall (2) by at least one hinge (3), device wherein it incorporates at least one shoe (7) integral with the opening hatch (1) at one of its rims near to which the hinge or hinges (3) are positioned, such shoe (7) engaging below a bearing surface (10) integral with the wall (2) when the opening hatch (1) is in the closed position, the cooperation of the shoe (7) with its bearing surface (10) being such that the opening hatch (2) can not be distanced from the wall even if the hinge or hinges (3) have been destroyed.

2. A protection device according to claim 1, wherein the shoe (7) is fixed with respect to the opening hatch (1) and incorporates a wedge-shaped profile that is engaged under the bearing surface (10) when the opening hatch pivots on its hinges.

3. A protection device according to claim 2, wherein the bearing surface (10) is integral with an inner rim (14) of the opening (6) that is arranged on the vehicle wall (2) and which is blocked by the opening hatch (1), the bearing surface (10) thus being inside the vehicle when the opening hatch (1) is closed.

4. A protection device according to claim 1, wherein a bearing surface (10) and shoe (7) are positioned at each hinge (3).

5. A protection device according to claim 1, wherein at least one bearing surface (10) and at least one shoe (7) are positioned between two consecutive hinges (3).
